(19) United States
(12) Patent Application Publication
(10) Pub. No.: US 2016/0189226 A1
(43) Pub. Date: Jun. 30, 2016

(54) METHOD AND SYSTEM FOR ENABLING SKIPPING ADVERTISEMENTS FOR A CONTENT

(71) Applicant: Sanjeev Madhava Rao, Manhattan Beach, CA (US)

(72) Inventor: Sanjeev Madhava Rao, Manhattan Beach, CA (US)

(21) Appl. No.: 14/587,199

(22) Filed: Dec. 31, 2014

(51) Int. Cl. G06Q 30/02

(52) U.S. Cl. CPC G06Q 30/0258; G06Q 30/0275

(57) ABSTRACT

The present disclosure provides methods and systems for skipping one or more advertisements at a corresponding one or more advertisement slots in a content to be viewed by a user on a publisher. The method and systems includes verifying the user of the one or more users with a list of stored one or more registered users to check registration of the user, providing a first pre-determined probabilistic amount for each of the one or more advertisement slots and a provision to skip one or more advertisements in each of the one or more advertisement slots, comparing a second pre-determined amount decided by the verified user for the one or more advertisement slots with a corresponding value from the first pre-determined probabilistic amount and enabling a decision of skipping of the one or more advertisements in the one or more advertisement slots based on the comparison.

### TECHNICAL FIELD

The present invention relates to the field of electronic advertising and in particular, relates to methods and systems for skipping of electronic advertisements.

### BACKGROUND

Advertising is an ever evolving industry which functions on a fact of survival of the fittest. With an increasing percentage of the consumer demographics opting to explore online services, internet advertising is now a multi-billion dollar industry. Many publishers create content only to earn revenue by displaying advertisements alongside the content.

More often than not, these advertisements irritate a user. The user gets interrupted every time when the advertisements are encountered in viewing of the content. Further, nobody has time to watch the advertisements that do not suit his/her interests. For example, a male user while watching a video on youtube encounters an advertisement regarding female products. The advertisement does not suit his interest and may annoy him. This is a big concern for publishers in terms of their online marketing strategy. The publishers are focusing on capturing the attention of users who are adamant towards internet advertising or in particular video advertising despite the user bypassing the internet advertisements. Moreover, the publishers are trying to maximize their monetization of their content through various video advertisement networks.

In the present scenario, some publishers provide a direct option to the user for skipping the in-stream advertisements by just simply clicking on the skip advertisement button. This is the easiest way of skipping the advertisements. Further, some systems provide the user an option of blocking the advertisements through various advertisement blocking softwares available on the internet. In addition, some current methods allow the users to skip the advertisements by paying an amount of money to the publisher.

In an example, a U.S. Patent Application U.S. 20130198013 A1 provides systems and methods for an electronic brokerage allowing consumer-initiated payment to skip electronic advertisements at publisher electronic content interfaces are provided. According to one embodiment of this patent application, an electronic brokerage is designed to allow paid, consumer-initiated advertisement skipping, which involves providing secured electronic client code and processes that are placed on publisher electronic content interfaces that execute within consumer browsers to allow consumers to choose whether they wish to pay to skip specific electronic advertising opportunities. These electronic brokerage systems allow publishers and consumers to securely register accounts with the brokerage that are used, respectively, to provide non-repudiated electronic advertising opportunity attestation and explicit consent/dissent to pay to skip those advertising opportunities.

The present methods and system of letting the users being given a choice to skip the video advertisements are not feasible. There is a lack of transparency for a viewer. The viewer has no idea behind asking for payment for skipping the advertisements. Further, the publishers might charge more amount of money from the users to skip the advertisements than the amount defined in a contract between the publisher and an advertiser. Further, some publishers do not provide the users an option for skipping advertisements. Therefore, the users are forced to view the advertisements in viewing of the content.

In the light of the above stated discussion, there is a need for a method and system that overcomes the above stated disadvantages.

### SUMMARY

In an aspect of the present disclosure, a computer-implemented method for skipping one or more advertisements at a corresponding one or more advertisement slots in a content to be viewed by a user of one or more users on a publisher of one or more publishers is provided. The computer-implemented method includes verifying, with a processor, the user of the one or more users with a list of stored one or more registered users to check registration of the user, providing, with the processor, a first pre-determined probabilistic amount for each of the one or more advertisement slots and a provision to skip one or more advertisements in each of the one or more advertisement slots, comparing, with the processor, a second pre-determined amount decided by the verified user for the one or more advertisement slots with a corresponding value from the first pre-determined probabilistic amount for each of the one or more advertisement slots and enabling, with the processor, a decision of skipping of the one or more advertisements in the one or more advertisement slots based on the comparison. Each of the first pre-determined probabilistic amount is calculated for each of the verified user and the one or more users for each of the one or more advertisement slots based on a bidding criterion. The bidding criterion is based on a corresponding bidding amount determined by a real time bidding auction and a statistical history for each of the one or more advertisement slots for each of the verified user and the one or more users. The second pre-determined amount for each of the one or more advertisements decided by the verified user is an amount set by the verified user for skipping a corresponding advertisement of the one or more advertisements in each of the one or more advertisement slots.

In an embodiment of the present disclosure, the computer-implemented method includes registration of the one or more users to enable skipping of the one or more advertisements in the content.

In an embodiment of the present disclosure, the computer-implemented method includes maintaining information of the one or more users, the first pre-determined probabilistic amount for each of the one or more advertisement slots and the second pre-determined amount for the one or more advertisement slots.

In an embodiment of the present disclosure, the computer-implemented method includes generating a cookie ID for each of the one or more users. In an embodiment of the present disclosure, the computer-implemented method includes dropping the cookie ID on one or more communication devices associated with the corresponding one or more users for extracting information of the one or more users.

In an embodiment of the present disclosure, the first pre-determined probabilistic amount is further based on at least one of compensation methods including cost per click, cost per impression and cost per view.

In an embodiment of the present disclosure, the computer-implemented method includes configuring on-demand desktop experience through a remote control application running on the one or more communication devices.

In another aspect of the present disclosure, a computer system is provided. The computer system includes a non-transitory computer readable medium storing a computer readable program; the computer readable program when executed on a computer causes the computer to perform steps. The steps include verifying a user of one or more users with a list of stored one or more registered users to check registration of the user, providing a first pre-determined probabilistic amount for each of one or more advertisement slots and a provision to skip one or more advertisements in each of the one or more advertisement slots, comparing a second pre-determined amount decided by the verified user for the one or more advertisement slots with a corresponding value from the first pre-determined probabilistic amount for each of the one or more advertisement slots and enabling a decision of skipping of the one or more advertisements in the one or more advertisement slots based on the comparison. Each of the first pre-determined probabilistic amount is calculated for each of the verified user and the one or more users for each of the one or more advertisement slots based on a bidding criterion. The bidding criterion is based on a corresponding bidding amount determined by a real time bidding auction and a statistical history for each of the one or more advertisement slots for each of the verified user and the one or more users. The second pre-determined amount for each of the one or more advertisements decided by the verified user is an amount set by the verified user for skipping a corresponding advertisement of the one or more advertisements in each of the one or more advertisement slots.

In an embodiment of the present disclosure, the computer readable program when executed on the computer causes the computer to perform the step of maintaining information of the one or more users, the first pre-determined probabilistic amount for each of the one or more advertisement slots and the second pre-determined amount for the one or more advertisement slots.

In an embodiment of the present disclosure, the computer readable program when executed on the computer causes the computer to perform the step of generating a cookie ID for each of the one or more users.

In yet another aspect of the present disclosure, a system for skipping one or more advertisements at a corresponding one or more advertisement slots in a content to be viewed by a user of one or more users on a publisher of one or more publishers is provided. The system includes a mapping module in a processor configured to verify the user of the one or more users with a list of stored one or more registered users to check registration of the user, an output engine in the processor configured to provide a first pre-determined probabilistic amount for each of the one or more advertisement slots and a provision to skip one or more advertisements in each of the one or more advertisement slots, a comparator module in the processor configured to compare a second pre-determined amount decided by the verified user for the one or more advertisement slots with a corresponding value from the first pre-determined probabilistic amount for each of the one or more advertisement slots and a decision module in the processor configured to enable a decision of skipping of the one or more advertisements in the one or more advertisement slots based on the comparison. Each of the first pre-determined probabilistic amount is calculated for each of the verified user and the one or more users for each of the one or more advertisement slots based on a bidding criterion. The bidding criterion is based on a corresponding bidding amount determined by a real time bidding auction and a statistical history for each of the one or more advertisement slots for each of the verified user and the one or more users. The second pre-determined amount for each of the one or more advertisements decided by the verified user is an amount set by the verified user for skipping a corresponding advertisement of the one or more advertisements in each of the one or more advertisement slots.

In an embodiment of the present disclosure, the system further includes a registration engine in the processor configured to register the one or more users for enabling skipping of the one or more advertisements.

In an embodiment of the present disclosure, the system further includes an execution engine in the processor configured to skip the one or more advertisements. The execution engine in the processor is further configured to generate a cookie ID for each of the one or more users. In addition, the execution engine in the processor is further configured to drop the cookie ID on one or more communication devices associated with the corresponding one or more users for extracting information of each of the one or more users.

In an embodiment of the present disclosure, the system further includes a database in the processor configured to maintain information of the one or more users, the first pre-determined probabilistic amount for each of the one or more advertisement slots, and the a second pre-determined amount for the one or more advertisement slots. The first pre-determined probabilistic amount is further based on at least one of compensation methods including cost per click, cost per impression and cost per view.

### BRIEF DESCRIPTION OF THE FIGURES

Having thus described the invention in general terms, reference will now be made to the accompanying drawings, which are not necessarily drawn to scale, and wherein:

FIG. 1 illustrates a system for performing real time bidding in an online advertising, in accordance with various embodiments of the present disclosure;

FIG. 2A and FIG. 2B illustrate a system for skipping of online advertisement in one or more video content, in accordance with various embodiments of the present disclosure;

FIG. 3 illustrates a block diagram of a communication device, in accordance with various embodiments of the present disclosure; and

FIG. 4 illustrates a flowchart for skipping the one or more advertisements, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

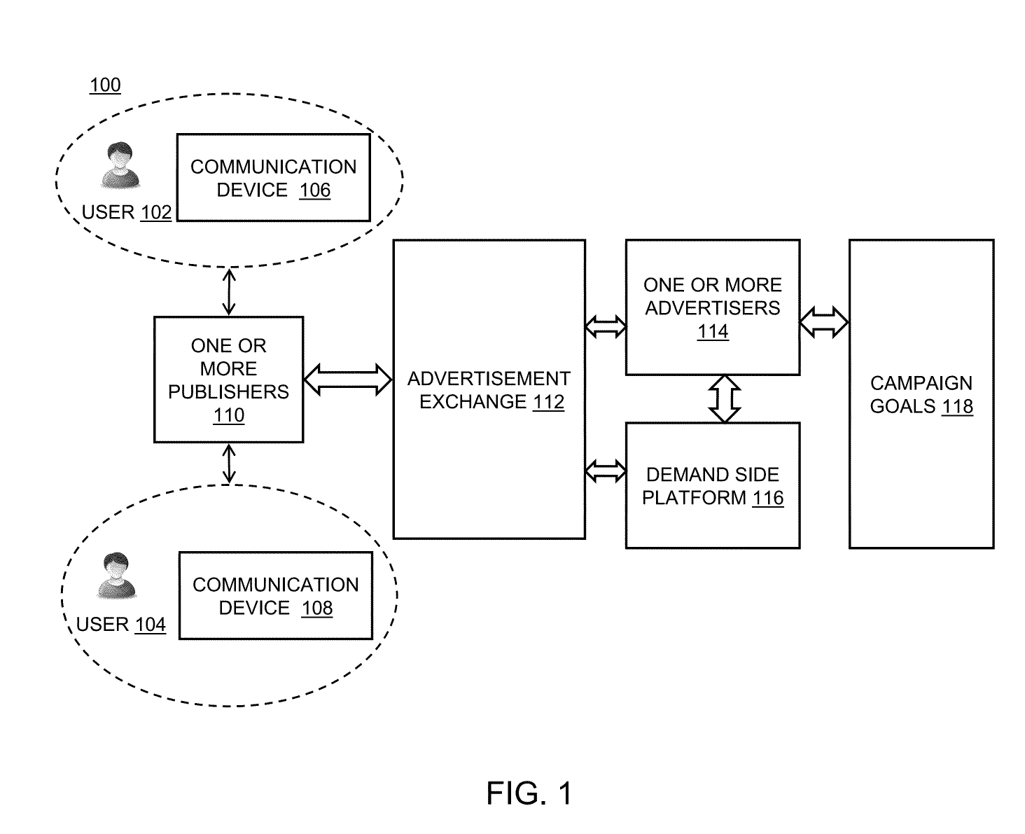

FIG. 1 illustrates a general overview of a system 100 for performing real time bidding in advertising, in accordance with various embodiments of the present disclosure. The system 100 includes a communication device 106 associated with a user 102, a communication device 108 associated with a user 104, one or more publishers 110, an advertisement exchange 112, one or more advertisers114, a demand side platform 116 and a plurality of campaign goals 118. The user 102-104 maybe any person or individual accessing the communication device 106-108. Examples of the communication device 106-108 include but may not be limited to mobile phones, computers, laptops, tablets, a television set and a portable digital assistant (PDA). The communication device 106-108 is connected to an internet broadband system, a local area network, a wide area network, a digital or analog cable television network or any other communication network presently known in the art. The internet broadband system maybe a wired or a wireless system. For example, the communication device 106 can also be a television connected to a cable network. The advertisement can be an online advertisement or an offline advertisement. In addition, the advertisement can be an audio advertisement, video advertisement, textual advertisement, html advertisement, flash advertisement, a short survey/poll or any other type of advertisement presently known in the art.

In an example, the user 102 accesses a browser of one or more browsers through the communication device 106 to access a website owned by a publisher of the one or more publishers 110. Examples of the one or more publishers 110 include but may not be limited to youtube, dailymotion, facebook, news channels, movie channels and mobile applications. Each of the one or more publishers 110 are website owners who provide or display content to the users102-104. The content may include one or more publisher content, one or more video content, one or more audio content, one or more text content, one or more HTML content, one or more flash content and any other content which is presently known in the art. Further, the content may be an online content or offline content, live or delayed, video on demand, packaged as streaming and the like. Moreover, the content may take a form of mobile applications and games providing display of the one or more advertisements. In an embodiment of the present disclosure, the website accessed by the communication device 106-108 may show content related to interests of the user 102-104. For example, the user 102 may be interested in watching online videos, reading blogs, play online games, accessing social networking sites, watching news channels on television, accessing mobile applications and the like. However, the user 102 encounters one or more advertisements while accessing the one or more publishers 110 website. The one or more advertisements include audio advertisements, video advertisements, textual advertisements, flash advertisements, rich media advertisements (For example, HTML advertisement) and the like. Further, an advertisement from the one or more advertisements may be in a form of a short survey poll for promotion.

The one or more publishers 110 provide space, areas or a part of their web pages for advertising purposes. These areas or spaces on the web pages are referred to as advertisement slots. The web page can have the various advertisement slots depending on choice of each of the one or more publishers 110. The one or more publishers 110 advertise products, services or businesses to the users 102-104 for generating revenue. It may be noted that the term publisher in context of the present application may be referred to as publisher website which may have advertisement slots for advertising. In an embodiment, the one or more publishers 110 are associated with the one or more advertisers 114 through the advertisement exchange 112. The one or more advertisers114 provide advertisements to the one or more publishers 110 for displaying on their website. The advertisements are placed on the advertisement slots on the website.

The one or more advertisers 114 purchase the advertisement slots from the one or more publishers 110. The advertisement exchange 112 is a platform for buying and selling of advertisement inventory between the one or more publishers 110 and the one or more advertisers 114. The advertisement exchange 112 manages the advertisement slots provided by the one or more publishers 110. Further, the advertisement exchange 112 works as a third party medium for efficient buying and selling of the advertisement inventory. In addition, the advertisement exchange 112 provides services for trading of the advertisement slots between a buyer and a seller. In an embodiment of the present disclosure, the buyer is the one or more advertisers 114 who aim to buy the advertisement slots and the seller is the one or more publishers 110 who aim to sell the advertisement slots of their website. Examples of the advertisement exchange 112 include but may not be limited to Microsoft AdECN, Yahoo Right Media, DoubleClick, AppNexus, OpenX and the like. In an embodiment of the present disclosure, the one or more publishers 110 and the one or more advertisers114 deal directly with each other without intervention of the advertisement exchange 112.

Going further, the one or more advertisers 114 are associated with the demand side platform 116. The demand-side platform 116 is a software for purchasing advertisements in an automated fashion. The demand side platform 116 allows the one or more advertisers 114 to buy the advertisement slots across a range of websites. Furthermore, the demand side platform 116 is a tool that automates purchasing of the advertisement slots on behalf of the one or more advertisers 114. The one or more advertisers 114 use the demand side platform 116 for setting buying parameters of their campaigns and to monitor campaign performance. Examples of the demand side platform 116 include but may not be limited to Google's Invite Media, MediaMath, Turn, DataXu,and X+1. The one or more advertisers 114 have the plurality of campaign goals 118. The one or more advertisers 114 set one or more goals according to their business products. The one or more advertisers 114 aim at targeting specific group of users who might be interested in their product. In an embodiment of the present disclosure, the one or more advertisers 114 may want to target a specific age group. For example, an advertiser X deals in selling women apparels might want to target women in the age group of 20-35 and has a fixed amount of budget expenditure.

The demand side platform 116 targets the specific group of users and makes a decision of placing the one or more advertisements of each of the one or more advertisers 114 on the advertisement slots associated with the one or more publishers 110. Moreover, the demand side platform 116 analyzes the plurality of campaign goals 118 and the information related to the user 102-104. The information related to the user 102-104 may include demographic information, geographical information and the like. The information of the user 102-104 may be tracked through one or more cookies. In addition, the demand side platform 116 receives information about the advertisement slots. The information include but may not be limited to the one or more publishers 110, size of advertisements, identifier related to the one or more publishers 110, the content and web traffic related to the one or more publishers 110 website and the like.

The advertisement exchange 112 facilitates the buying and selling of advertisement inventory or advertisement slots through the real time bidding. The real time bidding allows the one or more advertisers 114 and the one or more publishers 110 to take part in a real time auction facilitated by the advertisement exchange 112. The one or more publishers 110 provide the advertisement slots to the advertisement exchange 112. The demand side platform 116 decides the advertisement slots the one or more advertisers 114 should buy. The price of the advertisement slots is decided through the real time auction. The real time auction takes place in milliseconds before the web page loads. The one or more publishers 110 provide their advertisement inventory to the advertisement exchange 112which holds the real time auction. The demand side platform 116 bids on behalf of the one or more advertisers 114 for winning the advertisement slots. Value of a bid placed by the demand side platform 116 for the one or more advertisers 114 is determined by the buying parameters set by the one or more advertisers114. The real time bidding process terminates many advertisers from the one or more advertisers 114 as an advertiser with a highest bid is declared the winner of a particular advertisement slot from the one or more advertisement slots and allowed to show his or her advertisement in the particular advertisement slot on the websites.

It may be noted that the users 102-104 are associated with the respective communication device 106-108 for accessing the one or more publishers 110 website; however those skilled in the art would appreciate that the user 102 may be associated with more number of communication devices for accessing more number of publisher websites. For example, a user X, a user Y and a user Z are associated with a communication device D1, a communication device D2 and a communication device D3. In addition, there can be more than one advertisement exchanges bidding for one or more advertisement slots.

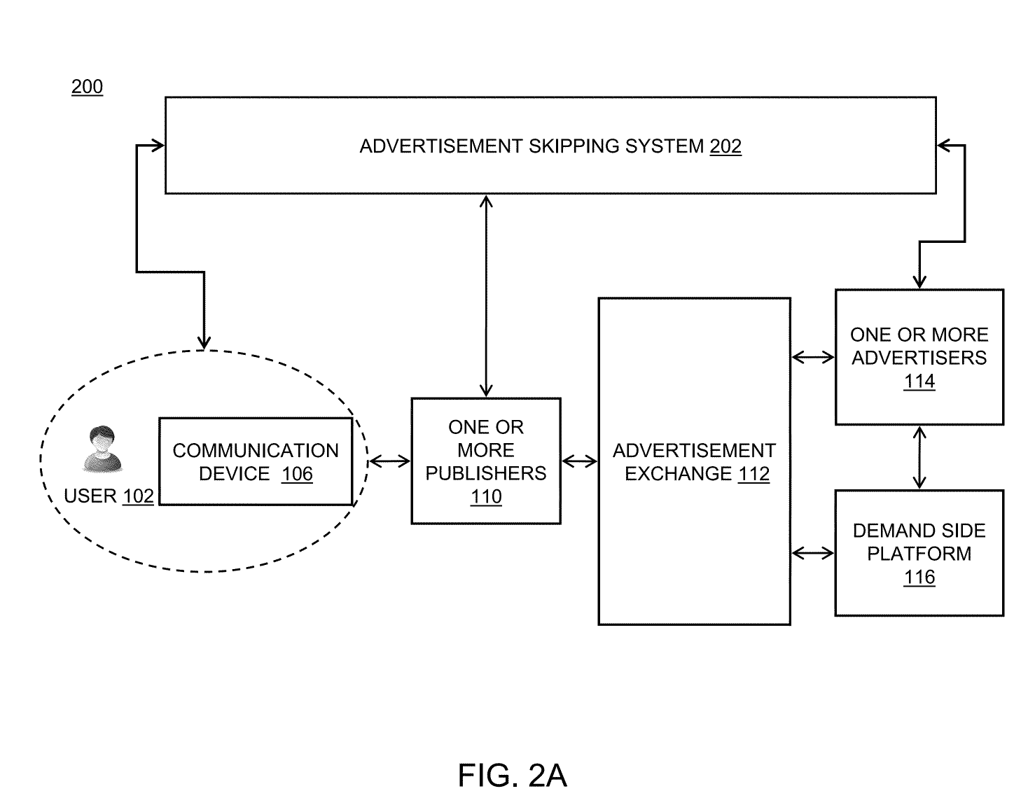

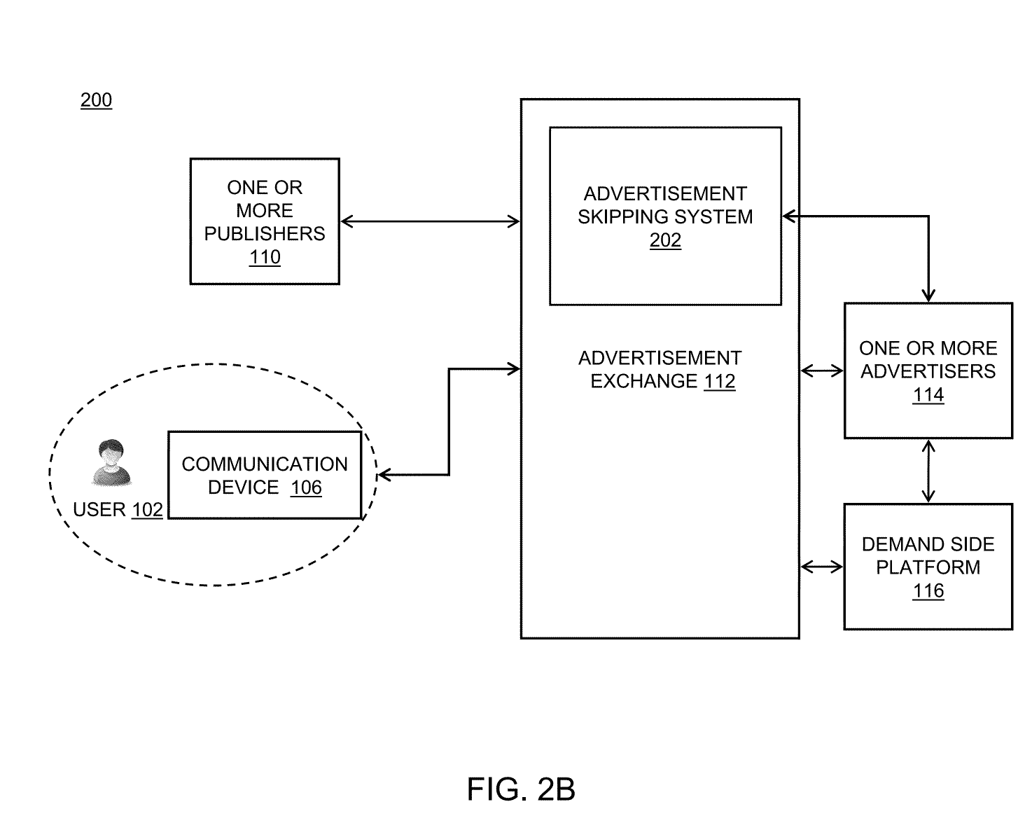

FIG. 2A illustrates a system 200 for enabling skipping one or more advertisements at a corresponding one or more advertisement slots in the content, in accordance with various embodiments of the present disclosure.

The system 200 includes an advertisement skipping system 202, the communication device 106 associated with the user 102, the one or more publishers 110, the advertisement exchange 112, the one or more advertisers 114 and the demand side platform 116. The user 102 is associated with the communication device 106 for accessing the one or more publishers 110 (websites). The user 102 may be any individual accessing the communication device 106. The one or more publishers 110 are the website owners providing the content to the user 102 according to his or her interests. For example, a user B may visit the website (www.youtube.com) for watching videos. In another embodiment of the present disclosure, the one or publishers 110 can be a mobile gaming company providing different mobile games to users to interact with. In yet another embodiment of the present disclosure, the one or more publishers 110 can be a mobile application (say a mobile application of a travel trip planner advisory company).

While watching the content (say a video) on a website of a publisher website of one or more publishers 110 websites, the user 102 may have to watch the one or more advertisements at different advertisement time slots. For example, the content may be a video of an episode of a popular TV series show X. The creator of the popular TV series show and the publisher who host the video may give advertiser an option to put the advertisement of its products/services at different time intervals, say at the starting of the video, after a pre-defined time interval or just before a crucial/critical scene of the video, and the like. In this example, if the user watches the advertisement while watching that video, the publisher and/or the content creator and vice versa may get revenue from the advertiser and/or advertisement. In an embodiment of the present disclosure, the content creator and/or the publisher or vice versa share the revenue received from the advertiser and/or advertisement exchange in a pre-set ratio (say 50:50, 100:0, 01:100, etc.). In another example, the user 102 may encounter advertisements while playing mobile games or accessing a utility mobile application.

In an embodiment of the present disclosure, the advertisement skipping system 202 provides the user 102 with a provision of skipping the video advertisement encountered in the video on the one or more publishers 110 website. In another embodiment of the present disclosure, the advertisement skipping system 202 provides the user 102 with a provision of skipping the advertisement encountered while playing mobile games or accessing a utility mobile application.

The advertisement skipping system 202 is associated with the one or more publishers 110 and the user 102. The advertisement skipping system 202 allows the one or more publishers 110 to offer the user 102 an option to skip broadband video commercials embedded in the video content for an amount to be paid by the user 102 to the one or more publishers 110(explained later in the patent application). In an embodiment of the present disclosure, the advertisement skipping system 202 displays a pop up to the user 102 as soon as the user 102 encounters the video advertisement. The advertisement skipping system 202 gives the user 102 choice to skip the video advertisement.

In an embodiment of the present disclosure, the advertisement skipping system 202 maps the user 102 with the one or more registered users to check registration of the user 102 for enabling skipping of the one or more advertisements in the one or more content for a the user 102. If the user 102 is a registered user with the advertisement skipping system 202, the user 102 may be asked to set a pre-determined amount of money for skipping advertisement in each of the advertisements slots in the video. In another embodiment of the present disclosure, the user 102 may be provided an option to set a pre-determined amount of money for the whole content which he/she may be able to pay for watching the content while skipping the maximum/optimum number of advertisements. In yet another embodiment of the present disclosure, the user 102 may be given both the options of setting a pre-determined amount of money for skipping advertisement in each of the advertisements slots in the content and an option to set a pre-determined amount of money for the whole content which he/she may be able to pay for watching the content while skipping the maximum/optimum number of advertisements.

In an embodiment of the present disclosure, the advertisement skipping system 202 enables skipping of those advertisements for which the amount set by the user 102 exceeds or equals to a fees calculated by the advertisement skipping system 202. In an embodiment of the present disclosure, the fees calculated by the advertisement skipping system 202 for each advertisement slot in the content is determined at least in part by calculating an probabilistic amount which the one or more publishers 110 would have got from the advertisers 114 and/or advertisement exchange in the real time bidding or past data of real time bidding had the user 102 not even opted to exploring the option to skip the advertisement. In an embodiment of the present disclosure, the probabilistic amount may be based on the attributes of the user 102, past data related to the advertisement slots, and the like. In another embodiment of the present disclosure, the advertisement skipping system 202 may consider the total amount set by the user 102 to skip the optimum number of advertisements in a video to determine which advertisement the user 102 may be allowed to skip.

The advertisement skipping system 202 recognizes an authorized user with the cookie stored on the communication device 106. In an embodiment of the present disclosure, the administrators of the advertisement skipping system 202 and the one or more publishers 110 have an agreement related to the amount paid by the advertisement skipping system 202 to the one or more publishers 110. The one or more publishers 110 keep a track of the skipped advertisements which helps in targeting a specific audience. Continuing with the above stated example, a user B has an account on the advertisement skipping system 202 and accesses the publisher X for watching a video Y. The video Y may have four advertisement slots (say at time t1, t2, t3 and t4). In an embodiment of the present disclosure, the user B may be given an option to bid for skipping advertisement for each of four options. The user B bids a1 cents for slot t1, a2 cents for slot t2, a3 cents for slot t3 and a4 cents for slot t4. In another embodiment, the user B may be given an option to set a total bid amount (say a5 cents for skipping all the 4 advertisement slots). In yet another embodiment of the present disclosure, the user B may be given an option to bid for skipping advertisement for each of four options (user B bids a1 cents for slot t1, a2 cents for slot t2, a3 cents for slot t3 and a4 cents for slot t4) and an option to set a total bid amount (say a5 cents for skipping all the 4 advertisement slots).

In all the above stated embodiments, a probabilistic amount for each advertisement slot is determined. In the above example, a probabilistic amount may be calculated for slot t1, slot t2, slot t3 and slot t4. The probabilistic amount for each slot (slot t1, slot t2, slot t3 and slot t4) is calculated based on a plurality of pre-defined criterions. The plurality of pre-defined criterions may be based on calculation/determination of highest bid that advertisement slot (say slot t1) would have got had the user B planned to watch it. For example, the probabilistic amount for the slot t1 can be a7 cents. If a1 cents (bid made by the user B for slot t1) exceeds a7 cents, then the advertisement skipping system 202 may skip the advertisement in the slot t1 for the user B. In another embodiment of the present disclosure, the plurality of pre-defined criterion may be based on the past bidding history for those advertisement slots. In yet another embodiment of the present disclosure, the user B may have set a5 cents as a total amount of money the user B can afford to skip the advertisements in the video Y. In this embodiment, the advertisement skipping system 202maydetermine the probabilistic amount for each of the advertisement slot in the video Y. In this case, the advertisement skipping system 202 automatically determines the total number of advertisements that can be skipped in the video Y for the user X. For example, the probabilistic amount for the advertisements slots are all cents for slot t1, a12 cents for slot t2, a13 cents for slot t3 and a14 cents for slots t4. In this case, the advertisement skipping system 202 may determine the maximum number of advertisements that can be skipped for the user B. The advertisement skipping system 202 may utilize an algorithm to determine the maximum number of advertisement which the user B may be able to skip. For example, if the total of all cents, a12 cents and a14 cents is less than a5 cents, then the user B may not be presented with the advertisement at slot t1, t2 and t4. It may be noted that the advertisement skipping system 202 may employ an algorithm to skip maximum number or an optimum number of advertisements.

In an embodiment of the present disclosure, the advertisement skipping system 202 provides a first pre-determined probabilistic amount to the user 102. The first pre-determined probabilistic amount is calculated based on a bidding criterion. The bidding criterion decides a bidding amount paid by the user 102 on viewing the one or more advertisements. The bidding criterion is the real time bidding process taking place between the one or more publishers 110 and the one or more advertisers 114 through the advertisement exchange 112 when the user 102 (registered user) loads the one or more video content on the one or more publishers 110 website. The real time bidding process generates a bidding amount to be paid by the user 102. The bidding amount is calculated based on at least one of compensation methods. The compensation methods include cost per click, cost per impression, cost per view and the like.

In an embodiment of the present disclosure, the user 102 decides a second pre-determined amount to be paid by the user 102 to the one or more publishers 110 for the one or more advertisements. The advertisement skipping system 202 compares the second pre-determined with the first pre-determined probabilistic amount for each advertisement slots. Moreover, the advertisement skipping system 202 skips the one or more advertisements when the second pre-determined amount exceeds the first pre-determined probabilistic amount. However, if the first pre-determined probabilistic amount exceeds the second pre-determined amount, the advertisement skipping system 202 does not skip the one or more advertisements for the user 102.

For example, the advertisement skipping system 202 may ask the user to pay at least 0.05 dollar to be authorized to skip the one or more advertisements. The user 102 may fund his or her account with various online payment methods. The online payment methods include but may not be limited to credit cards, debit cards, digital wallet, mobile payment and bit coins. The one or more publishers 110 partner with the advertisement skipping system 202 for allowing the user 102 for skipping the one or more advertisements.

In an embodiment of the present disclosure, if the user 102 is not the registered user with the advertisement skipping system 202, the advertisement skipping system 202 provides the user 102 with the provision to skip the one or more advertisements of the content by prompting the user 102 to sign up for an account on the advertisement skipping system 202. In an embodiment of the present disclosure, the advertisement skipping system 202 maintains databases of the one or more registered users, the first pre-determined probabilistic amount and the second pre-determined amount.

In yet another embodiment of the present disclosure, the advertisement skipping system 202 drops the cookie ID of the user 102 on the communication device 106 for extracting information of the user 102. In yet another embodiment of the present disclosure, the first pre-determined probabilistic amount being based on at least one of compensation methods including cost per click, cost per impression and cost per view. In yet another embodiment of the present disclosure, the system 200 allows configuration of on-demand desktop experience through a remote control application running on the communication device 106.

In yet another embodiment of the present disclosure, the user 102 saves the one or more video content to generate revenue during watching of the one or more video content. In yet another embodiment of the present disclosure, the user 102 may limit the delivery of the one or more advertisements in the one or more video content.

In yet another embodiment of the present disclosure, the user 102 may skip the one or more advertisements while watching the content on the television or while accessing a mobile application. For example, a user watches news on a news channel and a user B uses a mobile application on his/her smart phone. The user A skips the one or more advertisements in advertisement slots s1 and s2 of the advertisement slots s1, s2, s3, s4 and s5 in the news content and the user B skip the one or more advertisements in advertisement slots t1 and t3 of the advertisement slots t1, t2, t3 and t4 in the mobile application content.

It may be noted that the user 102 is associated with the communication device 106 for accessing the one or more publishers 110 website; however those skilled in the art would appreciate that there can be more users associated with more communication devices.

In an embodiment of the present disclosure, as illustrated in FIG. 2B, the advertisement skipping system 202 is a part of the advertisement exchange 112. In an embodiment of the present disclosure, the advertisement skipping system 202 illustrated in FIG. 2A and FIG. 2B may provide an advertisement skipping service which allows publishers110, to offer users, such as user 102, an option to skip electronic advertisements for a fee. For example, from the perspective of the user 102, when a video ad plays on a publisher's site that is a partner of the ad skipping service, the ad skipping service causes an invite to be displayed (e.g., in the top left corner of the ad) asking if user 102 would like to skip the ad. As described above, if user 102 is a registered customer of the ad skipping service and is logged in, user 102 can skip the ad by simply clicking the invite.

In an embodiment of the present disclosure, if user 102 is not a registered customer of the ad skipping service or not currently logged in, clicking on the invite pauses the ad and the invite expands to allow user 102 to sign up or sign in directly with the ad skipping service or by using social network authentication (e.g., the consumer's Facebook, Twitter or Google account).

In one embodiment of the present disclosure, the ad skipping service provides user 102 with choice and control, ease of use and a better online experience. The ad skipping service allows user 102 to control his/her ad experience by skipping video ads when desired, for a small fee per skip. As a result of not forcing user 102 to view ads to support the production, licensing and distribution of content, the advertisement skipping service provides user 102 with a better online experience. If user 102 wants to skip a particular ad, he/she can. And, if user 102 wants to watch it, he/she can.

As explained above, in order to skip ads, user 102 must have an account (e.g., a secure digital wallet) with the ad skipping service with a minimum level of funding (e.g., five dollars). In an embodiment of the present disclosure, the ad skipping service may accept multiple forms of payment to fund the account, such as electronic transfer (e.g., automated clearing house (ACH) transfer or wire transfer) from a designated bank account, credit card (e.g., Visa, MasterCard, Discover, American Express), online wallet (e.g., PayPal, Amazon Payments and Google Checkout) and/or mobile payment.

In an embodiment of the present disclosure, the user 102 may fund his/her secure digital wallet manually or by setting up auto-funding when the account falls below the minimum level of funding. The user 102 may be offered incentives to earn free skips or may be given coupons/discount to earn free skips. Free skips may be earned by user 102 for certain service milestones, e.g., signing up for an account, funding his/her account (e.g., one free skip for each dollar deposited over a minimum threshold), referrals and the like.

In one embodiment, the ad skipping service may recognize user 102 the same way other web services do, through the use of an anonymous cookie stored on the consumer's Internet connected device 106 (e.g., a desktop or laptop computer, a tablet computer or a smartphone). The user 102 can ensure he/she stays logged in to the ad skipping service by enabling cookies within their web browser. Examples of the web-browser include but may not be limited to Safari, Chrome, Internet Explorer, and Firefox.

In an embodiment of the present disclosure, various tools can be used by a publisher of the one or publishers 110 to credit its advertisers 114. In an embodiment of the present disclosure, the publisher of the one or publishers 110 is provided with access to a dashboard/user interface within the ad skipping service. This dashboard allows the publisher of the one or publishers 110 to download a comprehensive report on all ads that were skipped within a selectable date period or with any constraints. In an embodiment of the present disclosure, each of the one or more advertisers 114 may be provided with a corresponding dashboard/user interface. This corresponding dashboard/user interface may provide the advertisers 114 with business intelligence reports related to the advertisement skipping services.

The advertisement skipping services not only help users 102-104 with a better viewing experience but also allow publishers 110 to increase their available video ad inventory. The ad skipping service also allows publisher 110 to make more money by paying publishers 110 high CPMs for skipped ads. In addition, the ad skipping service enhances relationships between the one or more publishers110 and the one or more advertisers114. The one or more advertisers 114 are credited for skipped ads, thereby eliminating wasteful ad spending. In addition, by offering consumers a choice, the one or more publishers 110 offer a more engaging ad placement to advertisers, which increase the quality and relevancy of publisher's ad inventory.

It may be noted that for the sake of clarity of this disclosure, the content in which advertisements may be embedded is described as video content; however, those skilled in the art would appreciate that the displayed content may be in any other form which include but may not be limited to an audio content, a video content, and a textual content. In addition, for the sake of clarity and simplicity, the content explained in the embodiments may be an online content and the advertisements may be placed on the online publishers; however, those skilled in the art would appreciate that the content can be television content (or video on demand content) and the users are given to skip advertisements related to television content. It may also be noted that the user can skip the advertisements on different communication devices by using only a single account. For example, a credit lying for skipping advertisement on an android based mobile phone of a user can be used for skipping an advertisement for his windows based mobile phone or while watching a video on television (say video on demand) or while skipping an advertisement while playing a mobile game. It may also be noted that the user may have an aggregated account for his entire devices. In addition, the user may have different sub accounts for that aggregated account for skipping the advertisements. For example, the user may have a single account for his android device, television and a laptop. In addition, a sub account for each type of device may be linked with that single account. For example, there may be a sub-account for each of the different type of devices or different devices for the aggregated account for skipping the advertisements.

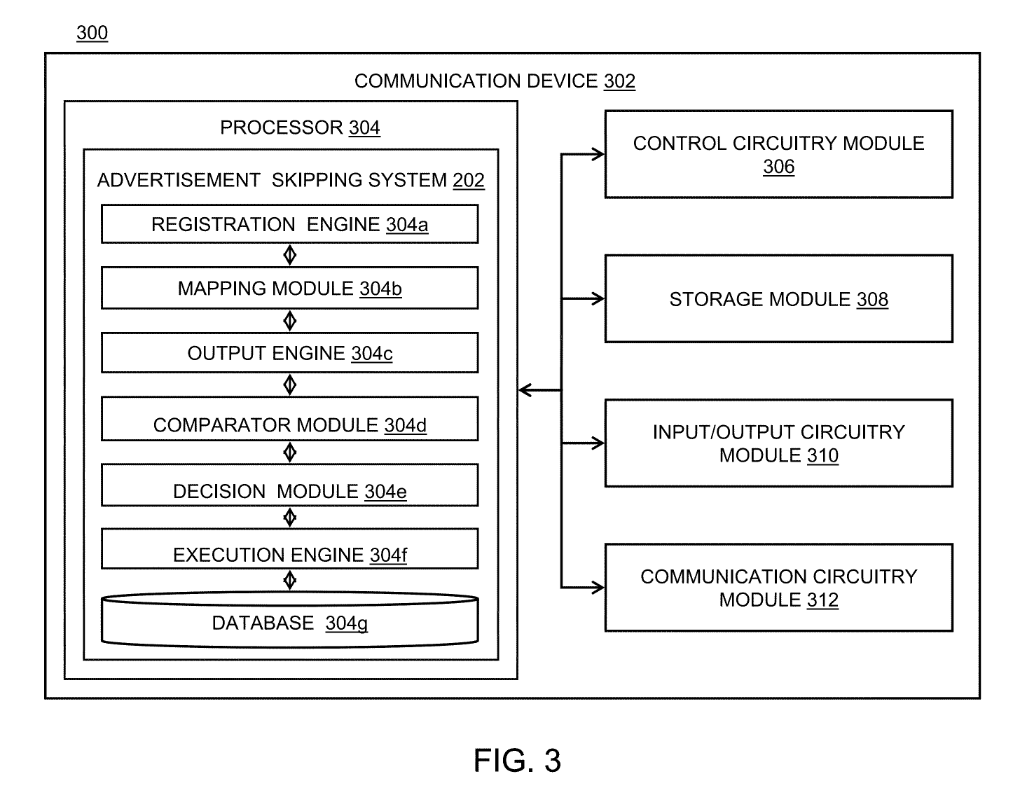

FIG. 3 illustrates a block diagram 300 of a communication device 302, in accordance with various embodiments of the present disclosure. The communication device 302 includes a processor 304, a control circuitry module 306, a storage module 308, an input/output circuitry module 310 and a communication circuitry module 312. Further, the processer 304 includes a registration engine 304a, a mapping module 304b, an output engine 304c, a comparator module 304d, a decision module 304e, an execution engine 304f and a database 304g. The above stated components of the processor 304 enables the working of the advertisement skipping system 202 for enabling skipping of the one or more advertisements of the video content. The advertisement skipping system 202 is associated with the user 102 and the one or more publishers 110 (as illustrated in the detailed description of FIG. 2Aand FIG. 2B).

The registration engine 304a registers the user 102 for enabling the skipping of the one or more advertisements in the one or more video content on the one or more publishers 110 website. The registration module 304a prompts the user 102 to sign up for the account if the user 102 is an unregistered user on the advertisement skipping system 202. The registration module 304a asks the user 102 to fill up a registration form and enter his/her information in the form. Further, the user 102 is asked to submit a payment online in order to be an authorized user for skipping the one or more advertisements (as described in detailed description of FIG. 2Aand FIG. 2B).

The mapping module 304b maps the user 102 with the one or more registered users to check registration of the user 102 for enabling skipping of the one or more advertisements (as described in detailed description of FIG. 2A). The output engine 304c delivers the first pre-determined probabilistic amount to the user 102 if the user 102 is the registered user. However, the delivering module 304c delivers the provision to skip the one or more advertisements of the video content to the user 102 if the user 102 is the unregistered user (as described in detailed description of FIG. 2A).

The comparator module 304d compares the second pre-determined amount with the first pre-determined probabilistic amount (as illustrated with the detailed description of FIG. 2A). The decision module 304e enables a decision of skipping of the one or more advertisements of the video content. The skipping of the one or more advertisements is performed on exceeding of value of the second pre-determined amount from the first pre-determined probabilistic amount.

The execution engine 304f performs skipping of the one or more advertisements for the user 102 based on the decision of the decision module 310. Further, the execution engine 304f generates the cookie ID for the user 102 and drops the corresponding cookie ID on the communication device 106 when the user 102 accesses the website. The cookie ID is used to extract information about the user 102 for distinguishing the registered users from the unregistered users. The database 304g stores the information related to the user 102, the first pre-determined probabilistic amount for each of the one or more advertisement slots and a second pre-determined amount for the one or more advertisement slots.

It may be noted that in FIG. 3, the mapping module maps the user 102 with the one or more registered users for enabling skipping of the one or more advertisements; however those skilled in the art would appreciate that more than one user can be mapped with the one or more registered users for enabling skipping of the one or more advertisements. It may also be noted that in FIG. 3, various modules of the advertisement skipping system 202 are shown that illustrates the working of the advertisement skipping system 202; however those skilled in the art would appreciate that the advertisement skipping system 202 may have more number of modules that could illustrate overall functioning of the advertisement skipping system 202.

The communication device 302 includes any suitable type of portable electronic device. Examples of the communication device 302 include but may not be limited to a high end laptop computer, a tablet computer, desktop computer, and a server having computational capabilities.

From the perspective of this disclosure, the control circuitry module 306 includes any processing circuitry or processor operative to control the operations and performance of the communication device 302. For example, the control circuitry module 306 may be used to run operating system applications, firmware applications, media playback applications, media editing applications, or any other application. In an embodiment, the control circuitry module 306 drives a display and process inputs received from a user interface.

From the perspective of this disclosure, the storage module 308 includes one or more storage mediums including a hard-drive, solid state drive, flash memory, permanent memory such as ROM, any other suitable type of storage component, or any combination thereof. The storage module 308 may store, for example, media data (e.g., music and video files), application data (e.g., for implementing functions on the communication device 302).

From the perspective of this disclosure, the I/O circuitry module 310 may be operative to convert (and encode/decode, if necessary) analog signals and other signals into digital data. In an embodiment, the I/O circuitry module 310 may also convert the digital data into any other type of signal and vice-versa. For example, the I/O circuitry module 310 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 306, the storage module 308 or any other component of the communication device 302.

It may be noted that the I/O circuitry module 310 is illustrated in FIG. 3 as a single component of the communication device 302; however those skilled in the art would appreciate that several instances of the I/O circuitry module 310 may be included in the communication device 302.

The communication device 302 may include any suitable interface or component for allowing the user 102 to provide inputs to the I/O circuitry module 310. The communication device 302 may include any suitable input mechanism. Examples of the input mechanism include but may not be limited to a button, keypad, dial, a click wheel, and a touch screen. In an embodiment, the communication device 302 may include a capacitive sensing mechanism, or a multi-touch capacitive sensing mechanism.

In an embodiment, the communication device 302 may include specialized output circuitry associated with output devices such as, for example, one or more audio outputs. The audio output may include one or more speakers built into the communication device 302, or an audio component that may be remotely coupled to the communication device 302.

The one or more speakers can be mono speakers, stereo speakers, or a combination of both. The audio component can be a headset, headphones or ear buds that may be coupled to the communication device 302 with a wire or wirelessly.

In an embodiment, the I/O circuitry module 310 may include display circuitry for providing a display visible to the user 102. For example, the display circuitry may include a screen (e.g., an LCD screen) that is incorporated in the communication device 302.

The display circuitry may include a movable display or a projecting system for providing a display of content on a surface remote from the communication device 302 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 306. Alternatively, the display circuitry may be operative to provide instructions to a remote display.

In addition, the communication device 302 includes the communication circuitry module 312. The communication circuitry module 312 may include any suitable communication circuitry operative to connect to a communication network and to transmit communications (e.g., voice or data) from the communication device 302 to other devices within the communications network. The communication circuitry module 312 may be operative to interface with the communication network using any suitable communication protocol. Examples of the communication protocol include but may not be limited to Wi-Fi, Bluetooth RTM, radio frequency systems, infrared, LTE, GSM, GSM plus EDGE, CDMA, and quadband.

In an embodiment, the communication circuitry module 312 may be operative to create a communications network using any suitable communications protocol. For example, the communication circuitry module 312 may create a short-range communication network using a short-range communications protocol to connect to other devices. For example, the communication circuitry module 312 may be operative to create a local communication network using the Bluetooth, RTM protocol to couple the communication device 302 with a Bluetooth, RTM headset.

It may be noted that the computing device is shown to have only one communication operation; however, those skilled in the art would appreciate that the communication device 302 may include one more instances of the communication circuitry module 312 for simultaneously performing several communication operations using different communication networks. For example, the communication device 302 may include a first instance of the communication circuitry module 312 for communicating over a cellular network, and a second instance of the communication circuitry module 312 for communicating over Wi-Fi or using Bluetooth RTM.

In an embodiment, the same instance of the communication circuitry module 312 may be operative to provide for communications over several communication networks. In an embodiment, the communication device 302 may be coupled a host device for data transfers, synching the communication device 302, software or firmware updates, providing performance information to a remote source (e.g., providing riding characteristics to a remote server) or performing any other suitable operation that may require the communication device 302 to be coupled to a host device. Several computing devices may be coupled to a single host device using the host device as a server. Alternatively or additionally, the communication device 302 may be coupled to the several host devices (e.g., for each of the plurality of the host devices to serve as a backup for data stored in the communication device 302).

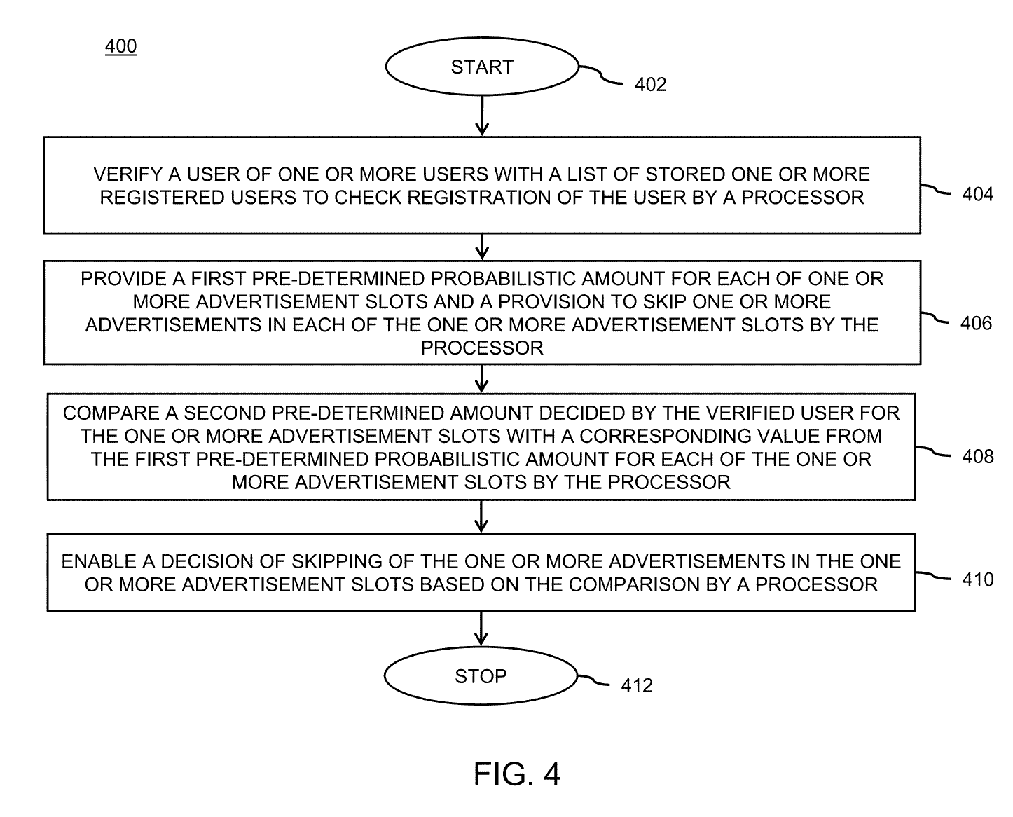

FIG. 4 illustrates a flowchart 400 for enabling skipping one or more advertisements at a corresponding one or more advertisement slots during displaying of a video content to be viewed by the user 102 of one or more users 102-104 on a publisher of one or more publishers 110, in accordance with various embodiments of the present disclosure. The flow chart 400 initiates at step 402. Following step 402, at step 404, as mentioned above, the advertisement skipping system 202 verifies the user 102 with the one or more users 102-104 with a list of stored one or more registered users to check registration of the user 102 for enabling skipping of the one or more advertisements. At step 406, the advertisement skipping system 202 provides the first pre-determined probabilistic amount for each of the one or more advertisement slots and a provision to skip the one or more advertisements in each of the one or more advertisement slots. Each of the first pre-determined probabilistic amounts is calculated for each of the verified users (registered users) and the one or more users (if unregistered) for each of the one or more advertisement slots based on the bidding criterion. As mentioned above, the bidding criterion is based on a corresponding bidding amount determined by a real time bidding auction and a statistical history for each of the one or more advertisement slots for each of the verified user and the one or more users. At step 508, the advertisement skipping system 202 compares the second pre-determined amount decided by the user 102 with the first pre-determined probabilistic amount calculated using the bidding criterion. The second pre-determined amount for each of the one or more advertisements decided by the verified user is an amount set by the verified user for skipping a corresponding advertisement of one or more advertisements in each of the one or more advertisements. At step 410, the advertisement skipping system 202 enables a decision of skipping of the one or more advertisements in the one or more advertisement slots based on the comparison. The flow chart 400 terminates at step 412.

It may be noted that the flowchart 400 is explained to have above stated process steps; however, those skilled in the art would appreciate that the flowchart 400 may have more/less number of process steps which may enable all the above stated embodiments of the present disclosure.

It may be noted the advertisement skipping system 202 may be shown to be implemented in an online advertising system; however, those skilled in the art would appreciate that the advertisement skipping system 202 may be implemented in advertisement inventories in different filed which include but may not be limited advertisement related to on-demand television content, and mobile applications. For example, the advertisement skipping system for recorded television serials/episodes broadcasted over the air may enable the user to skip the advertisement based on the criterion defined/explained above. Similarly, the video advertisements provided in the mobile applications may also be skipped on real time basis based on the fees provided by the user.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method for skipping one or more advertisements at corresponding one or more advertisement slots in a content to be viewed by a user of one or more users on a publisher of one or more publishers, the computer-implemented method comprising:
verifying, with a processor, said user of said one or more users with a list of stored one or more registered users to check registration of said user;
providing, with said processor, a first pre-determined probabilistic amount for each of said one or more advertisement slots and a provision to skip said one or more advertisements in each of said one or more advertisement slots, wherein said first pre-determined probabilistic amount being calculated for each of said verified user and said one or more users for each of said one or more advertisement slots based on a bidding criterion, said bidding criterion being based on a corresponding bidding amount determined by a real time bidding auction and a statistical history for each of said one or more advertisement slots for each of said verified user and said one or more users;
comparing, with said processor, a second pre-determined amount decided by said verified user for said one or more advertisement slots with a corresponding value from said first pre-determined probabilistic amount for each of said one or more advertisement slots, wherein said second pre-determined amount for each of said one or more advertisements decided by said verified user being an amount set by said verified user for skipping a corresponding advertisement of said one or more advertisements in each of said one or more advertisement slots; and
enabling, with said processor, a decision of said skipping of said one or more advertisements in said one or more advertisement slots based on said comparison.

2. The computer-implemented method as recited in claim 1, further comprising registering, with said processor, said one or more users to enable said skipping of said one or more advertisements in said content.

3. The computer-implemented method as recited in claim 1, further comprising maintaining, with said processor, information of said one or more users, said first pre-determined probabilistic amount for each of said one or more advertisement slots and said second pre-determined amount for said one or more advertisement slots.

4. The computer-implemented method as recited in claim 1, further comprising generating, with said processor, a cookie ID for each of said one or more users.

5. The computer-implemented method as recited in claim 1, further comprising dropping, with said processor, said cookie ID on one or more communication devices associated with corresponding said one or more users for extracting said information of said one or more users.

6. The computer-implemented method as recited in claim 1, wherein said first pre-determined probabilistic amount being further based on at least one of compensation methods comprising cost per click, cost per impression and cost per view.

7. The computer-implemented method as recited in claim 1, further comprising configuring, with said processor, on-demand desktop experience through a remote control application running on said one or more communication devices.

8. A computer program product comprising a non-transitory computer readable medium storing a computer readable program, wherein said computer readable program when executed on a computer causes said computer to perform steps comprising:
verifying a user of one or more users with a list of stored one or more registered users to check registration of said user;
providing a first pre-determined probabilistic amount for each of one or more advertisement slots and a provision to skip one or more advertisements in each of said one or more advertisement slots, wherein said first pre-determined probabilistic amount being calculated for each of said verified user and said one or more users for each of said one or more advertisement slots based on a bidding criterion, said bidding criterion being based on a corresponding bidding amount determined by a real time bidding auction and a statistical history for each of said one or more advertisement slots for each of said verified user and said one or more users;
comparing a second pre-determined amount decided by said verified user for said one or more advertisement slots with a corresponding value from said first pre-determined probabilistic amount for each of said one or more advertisement slots, wherein said second pre-determined amount for each of said one or more advertisements decided by said verified user being an amount set by said verified user for skipping a corresponding advertisement of said one or more advertisements in each of said one or more advertisement slots; and
enabling a decision of said skipping of said one or more advertisements in said one or more advertisement slots based on said comparison.

9. The computer program product as recited in claim 8, wherein said computer readable program when executed on said computer causes said computer to perform a step of maintaining information of said one or more users, said first pre-determined probabilistic amount for each of said one or more advertisement slots and said second pre-determined amount for said one or more advertisement slots.

10. The computer program product as recited in claim 8, wherein said computer readable program when executed on said computer causes said computer to perform a step of registering said one or more users to enable said skipping of said one or more advertisements in said content.

11. The computer program product as recited in claim 8, wherein said computer readable program when executed on said computer causes said computer to perform a step of generating a cookie ID for each of said one or more users.

12. The computer program product as recited in claim 11, wherein said computer readable program when executed on said computer causes said computer to perform said step of dropping said cookie ID on one or more communication devices associated with corresponding said one or more users for extracting said information of said one or more users.

13. The computer program product as recited in claim 8, wherein said first pre-determined probabilistic amount being further based on at least one of compensation methods comprising cost per click, cost per impression and cost per view.

14. A system for skipping one or more advertisements at corresponding one or more advertisement slots in a content to be viewed by a user of one or more users on a publisher of one or more publishers, the system comprising:
a mapping module in a processor being configured to verify said user of said one or more users with a list of stored one or more registered users to check registration of said user;
an output engine in said processor being configured to provide a first pre-determined probabilistic amount for each of said one or more advertisement slots and a provision to skip said one or more advertisements in each of said one or more advertisement slots, wherein said first pre-determined probabilistic amount being calculated for each of said verified user and said one or more users for each of said one or more advertisement slots based on a bidding criterion, said bidding criterion being based on a corresponding bidding amount determined by a real time bidding auction and a statistical history for each of said one or more advertisement slots for each of said verified user and said one or more users;
a comparator module in said processor being configured to compare a second pre-determined amount decided by said verified user for said one or more advertisement slots with a corresponding value from said first pre-determined probabilistic amount for each of said one or more advertisement slots, wherein said second pre-determined amount for each of said one or more advertisements decided by said verified user being an amount set by said verified user for skipping a corresponding advertisement of said one or more advertisements in each of said one or more advertisement slots; and
a decision module in said processor being configured to enable a decision of said skipping of said one or more advertisements in said one or more advertisement slots based on said comparison.

15. The system as recited in claim 14, further comprising a registration engine in said processor being configured to register said one or more users for enabling said skipping of said one or more advertisements.

16. The system as recited in claim 14, further comprising an execution engine in said processor being configured to skip said one or more advertisements.

17. The system as recited in claim 16, wherein said execution engine in said processor being further configured to generate a cookie ID for each of said one or more users.

18. The system as recited in claim 17, wherein said execution engine in said processor being further configured to drop said cookie ID on one or more communication devices associated with corresponding said one or more users for extracting information of each of said one or more users.

19. The system as recited in claim 14, further comprising a database in said processor being configured to maintain said information of said one or more users, said first pre-determined probabilistic amount for each of said one or more advertisement slots and said second pre-determined amount for said one or more advertisement slots.

20. The system as recited in claim 14, wherein said first pre-determined probabilistic amount being further based on at least one of compensation methods comprising cost per click, cost per impression and cost per view.
